(19) United States
(12) Patent Application Publication
(10) Pub. No.: US 2023/0121177 A1
(43) Pub. Date: Apr. 20, 2023

(54) Bagel and Roll Slicing Guide and Method

(71) Applicant: John M. Skoko, Montebello, CA (US)

(72) Inventor: John M. Skoko, Montebello, CA (US)

(21) Appl. No.: 17/966,028

(22) Filed: Oct. 14, 2022

Related U.S. Application Data
(60) Provisional application No. 63/360,569, filed on Oct. 15, 2021.

(51) Int. Cl. B26B 29/06; B26D 3/30

(52) U.S. Cl. CPC B26B 29/063; B26D 3/30

(57) ABSTRACT

A bagel slicing guide includes two narrow horizontal slots in two opposite sides. The guide includes a base and the sides reach up from opposite edges of the base. The slots are in the sides and spaced above and parallel with the base, the slots guiding a knife blade to establish a thickness of a sliced bagel or roll. The slots include at least one enlarged slot end to facilitate entry of a knife blade tip into the slots. The sides are short to provide a compact envelope not requiring very much storage space. The guide may be plastic or a single piece of metal, preferably stainless steel, and more preferably as single piece of stainless steel sheet bent to create the sides.

### CROSS-REFERENCE TO RELATED APPLICATIONS

The present application claims the priority of U.S. Provisional Patent Application Ser. No. 63/360,569 filed Oct. 15, 2021, which application is incorporated in its entirety herein by reference.

### BACKGROUND OF THE INVENTION

The present invention relates to slicing bagels and other food items, and in particular to a simple inexpensive knife guide for slicing bagels.

Bagels are generally sliced to provide a suitable thickness and a flat surface for butter and other toppings. A bagel can be sliced while holding in a hand, but a risk of cutting the hand is an issue.

Various US Patents, such as U.S. Pat. No. 6,543,322 filed by the present inventor, describes bagel cutters holding the bagel vertically. While these may work well, they also require a base and some vertical structure for holding the bagel, and require storage space which is often a premium in kitchens.

U.S. Pat. No. 4,546,686 describes a bagel slicer having a cavity for insertion of the bagel, and two stationary blades. The bagel is pushed into blades slicing the bagel. While the bagel slicer described in the '686 patent works well, it also is more complex than necessary. The slicer must be disassembled to clean blades 29 and 29′ causing undesirable work.

U.S. Pat. No. 4,550,636 describes a bagel slicer having an angled guide and allows use of a typical knife, but requires more space than necessary.

U.S. Pat. No. 7,690,285 describes a vegetable slicer which is complex and generally too expensive for occasional home use.

Thus a need exists for a simple, small, inexpensive bagel slicer.

### BRIEF SUMMARY OF THE INVENTION

The present invention addresses the above and other needs by providing a bagel slicing guide including two narrow horizontal slots in two opposite sides. The guide includes a base and the sides reach up from opposite edges of the base. The slots are in the sides and spaced above and parallel with the base, the slots guiding a knife blade to establish a thickness of a sliced bagel or roll. The slots include at least one enlarged slot end to facilitate entry of a knife blade tip into the slots. The sides are short to provide a compact envelope not requiring very much storage space. The guide may be plastic or a single piece of metal, preferably stainless steel, and more preferably as single piece of stainless steel sheet bent to create the sides.

In accordance with one aspect of the invention, there is provided a slicing guide suitable for bagels or rolls. Slots in short sides of the guide keep a knife blade parallel with a base of the guide to provide a uniform surface for butter or toppings.

In accordance with another aspect of the invention, there is provided a slicing guide having at least one enlarged slot end for easy insertion of a knife blade through opposite slots. The enlarged end may be on both ends of one slot, or both ends of both slots.

In accordance with yet another aspect of the invention, there is provided a simple slicing guide made from a single piece of metal. The metal is bent to provide a horizontal base and two opposite short sides. The simple single piece construction is inexpensive and easy to clean. A preferred material is stainless steel.

In accordance with another aspect of the invention, there is provided a slicing guide having three or four pads made of rubber or similar material. The pads resist sliding while slicing a bagel or roll.

In accordance with still another aspect of the invention, there is provided a method for slicing bagels or rolls. The method includes the steps of laying the bagel or roll into the base of the guide. Inserting a knife blade through a first slot. Guiding a tip of the knife blade over the base and through a second opposite slot. Holding down the bagel or roll with one hand. Slicing the bagel or roll with the knife held in a second hand. Because bagels are generally harder to cut than rolls, the bagel may be turned while slicing to make slicing easier. The slicing guide may include at least one enlarged slot end to facilitate insertion of the knife blade tip through both slots.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1 is an isometric view of a bagel or roll slicing guide according to the present invention.

FIG. 2 is a side view of the slicing guide according to the present invention.

FIG. 3 is an end view of the slicing guide according to the present invention.

FIG. 4 is a top view of the slicing guide according to the present invention.

FIG. 5 is a bottom view of the slicing guide according to the present invention.

FIG. 6 is a method of use for the bagel or roll slicing guide according to the present invention.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

Where the terms “about” or “generally” are associated with an element of the invention, it is intended to describe a feature's appearance to the human eye or human perception, and not a precise measurement, or typically within 10 percent of a stated value.

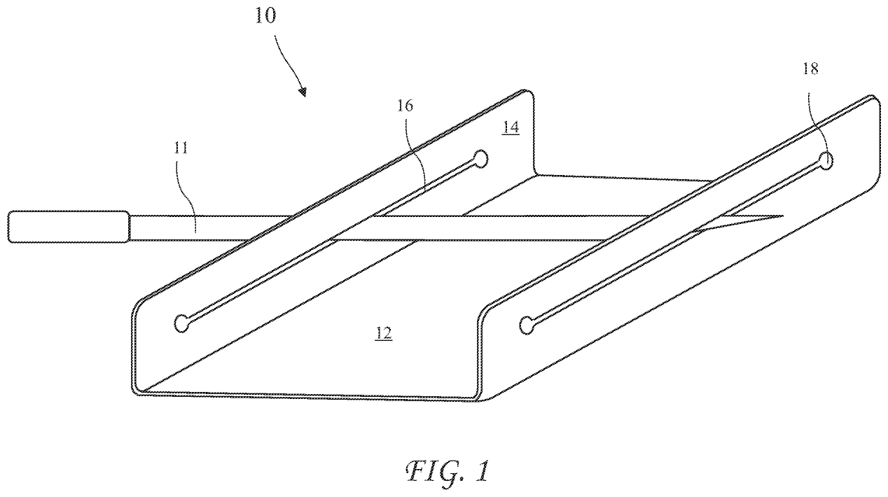

An isometric view of a bagel slicing guide 10 according to the present invention is shown in FIG. 1. The slicing guide 10 includes a base 12, opposing sides 14, slots 16 in the opposing sides 14, and preferably enlarged slot end 18 at the ends of each slot 16. A knife 11 is shown passing through the slots 16. The slicing guide 10 is preferably a single piece of bent metal, more preferably a single piece of bent stainless steel sheet, and most preferably a single piece of about 0.035 inches thick bent stainless steel sheet. The slicing guide 10 may also be made from plastic of the like.

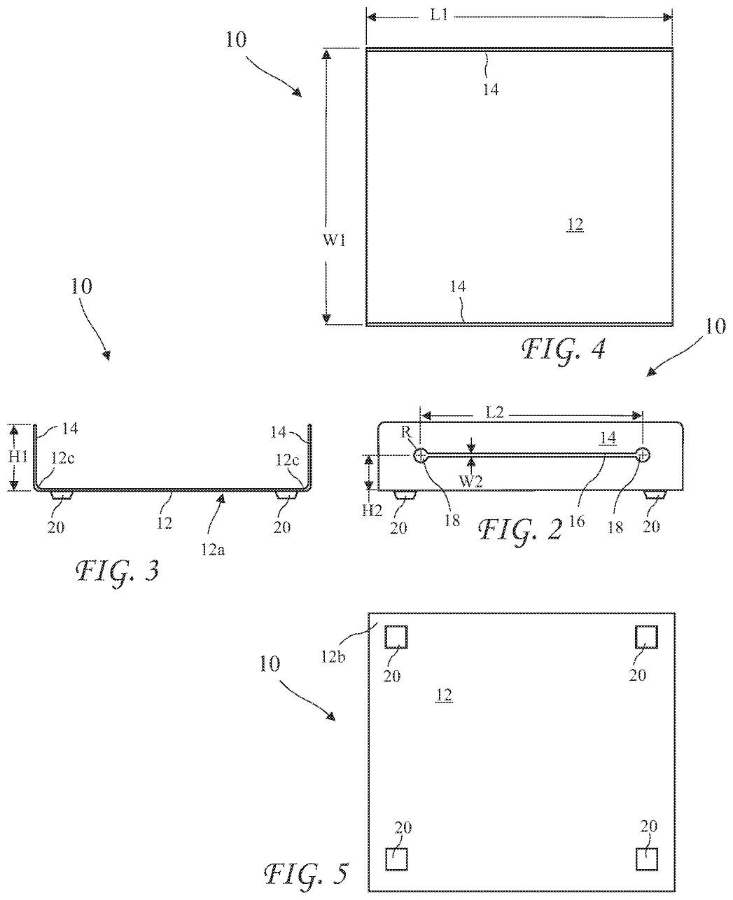

A side view of the slicing guide 10 is shown in FIG. 2, an end view of the slicing guide 10 is shown in FIG. 3, a top view of the slicing guide 10 is shown in FIG. 4, and a bottom view of the slicing guide 10 is shown in FIG. 5. The slots 16 reach up from edges 12c of the base 12 and are generally parallel with the base 12 and generally centered in the sides 14. Four pads or bumpers 20 are attached to a bottom 12a of the base 12 proximal to corners 12b of the base 12.

The slicing guide 10 had a length L1, width W1, and height H1. The length L1 is preferably about 6.5 inches and more preferably is 6.5 inches. The width W1 is preferably about 5 inches and more preferably is 5 inches. The height H1 is preferably about 1.25 inches and more preferably is 1.25 inches.

The slots 16 have a length L2, a height H2 above the base 12 and a width W2. The enlarged slot end 18 are preferably round with a radius R but are not necessarily round. The length L2 is preferably about 5 inches and more preferably is 5 inches. The height H2 is preferably about 0.625 inches and more preferably is 0.625 inches. The width W2 is preferably about 0.090 inches and more preferably is 0.090 inches. The radius R is preferably about 0.125 inches and more preferably is 0.125 inches. The enlarged slot end 18 is not necessarily round and may be other shapes with a vertical dimension of about 0.25 inches.

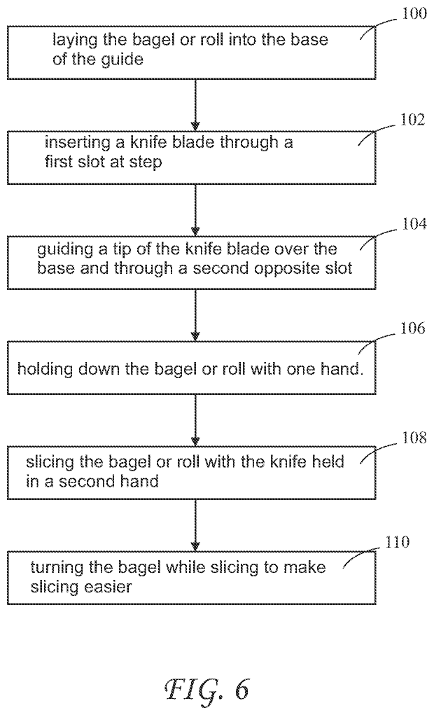

A method of use for the slicing guide 10 is described in FIG. 6. The method includes laying the bagel or roll into the base of the guide at step 100. Inserting a knife blade through a first slot at step 102. Guiding a tip of the knife blade over the base and through a second opposite slot at step 104. Holding down the bagel or roll with one hand at step 106. Slicing the bagel or roll with the knife held in a second hand at step 108. The steps 100 and 102 may be interchanged. Because bagels are generally harder to cut than rolls, the bagel may be turned while slicing to make slicing easier at step 110.

While the invention herein disclosed has been described by means of specific embodiments and applications thereof, numerous modifications and variations could be made thereto by those skilled in the art without departing from the scope of the invention set forth in the claims.

I claim:

1. A bagel or roll slicing guide comprising:
a base;
two sides reaching up from opposite sides of the base; and
slots in both sides, the slots generally parallel with the base.

2. The slicing guide of claim 1, wherein the base is flat and rectangular.

3. The slicing guide of claim 2, wherein the sides have a side height of about 1.25 inches.

4. The slicing guide of claim 5, wherein the base has a length of about 6.5 inches and a width of about 5 inches.

5. The slicing guide of claim 2, wherein the slots are about 5 inches long.

6. The slicing guide of claim 2, wherein at least one end of at least one of the slots is enlarged.

7. The slicing guide of claim 2, wherein:
the slots are about 0.090 inches wide and about 5 inches long; and
at least one end of at least one of the slots includes an enlarged slot end with a vertical dimension of about 0.25 inches.

8. The slicing guide of claim 7, wherein the enlarged slot end is generally round with a radius of about 0.125 inches.

9. The slicing guide of claim 8, wherein the enlarged slot end comprises enlarged slot ends on opposite ends of both slots.

10. The slicing guide of claim 1, further including bumpers on a bottom of the base proximal to each of four corners of the base.

11. A method for slicing bagels or rolls, the method comprising:
in any order:
laying the bagel or roll into a base of a slicing guide, the slicing guide comprising;
a base having a length of about 6.5 inches and a width of about 5 inches;
a first side and a second side opposite to the first side, both first and second sides reaching up from opposite edges of the base, the sides having a side height of about 1.25 inches; and
a first slot and a second opposite slot in the first side and the second side respectively, the slots generally parallel with the base, the slots about 5 inches long, about 0.090 inches wide, and having enlarged slot ends having a vertical dimension of about 0.25 inches, and
inserting a knife blade through a first slot and guiding a tip of the knife blade over the base and through the enlarged slot end of the second opposite slot;
holding down the bagel or roll with one hand; and
slicing the bagel or roll with the knife held in a second hand.

12. The method of claim 11, further including turning the bagel while slicing.

13. A bagel or roll slicing guide comprising:
a single piece of stainless steel sheet;
a base having a length of 6.5 inches and a width of 5 inches;
two 90 degree bends in the stainless steel sheet providing a first side and a second side opposite to the first side, both first and second sides reaching up from opposite edges of the base, the sides having a side length of 6.5 inches and a side height of 1.25 inches above the base; and
a first slot in the first side and a second opposite slot in the second side, the slots generally parallel with the base, the slots 0.625 inches above the base, 5 inches long, 0.090 inches wide, and having enlarged slot ends having a radius of 0.125 inches.
